(19) United States
(12) Patent Application Publication
(10) Pub. No.: US 2017/0112135 A1
(43) Pub. Date: Apr. 27, 2017

(54) Biocide Concentrate Composition for the Addition to Oil-Based Formulations, and Compositions Containing the Same

(71) Applicant: ARCH WOOD PROTECTION, INC, Atlanta, GA (US)

(72) Inventors: Roger Fox, Fayetteville, GA (US); Kimberlee Thompson, Decatur, GA (US)

(21) Appl. No.: 15/297,543

(22) Filed: Oct. 19, 2016

Related U.S. Application Data
(60) Provisional application No. 62/243,310, filed on Oct. 19, 2015.

(51) Int. Cl. A01N 61/02; A01N 43/653; B27K 3/46; B27K 3/08; B27K 3/34; A01N 25/22; A01N 25/02

(52) U.S. Cl. CPC A01N 61/02; A01N 25/22; A01N 43/653; A01N 25/02; B27K 3/08; B27K 3/343; B27K 3/46; B27K 2240/20

(57) ABSTRACT

Disclosed is a biocide concentrate composition to be incorporated into oil-based formulations useful for the treatment and preservation of wood. Also disclosed are oil-based biocide compositions and creosote based biocide compositions.

### CROSS REFERENCE TO RELATED-APPLICATION

This application claims priority under 35 U.S.C. §119(e) from Provisional Application No. 62/243,310 filed Oct. 19, 2015, which is herein incorporated by reference.

### BACKGROUND OF THE INVENTION

Field of the Invention

The present invention relates to a biocide concentrate composition which is used in oil-based formulations used to treat and preserve wood. The present invention also relates to oil-based biocide wood preservative, a method of using the wood preservative and a method of extending oil-based biocide wood preservative with an oil such that the properties of the oil-based biocide wood preservative are not diminished. More particularly, the present invention relates to a creosote-based wood preservative where part of the creosote is replaced with oil and the biocide concentrate composition, while maintaining the overall effectiveness of the wood preservative. A biocide formulation is provided for addition to creosote wood preservatives.

Background of the Prior Art

Oil-based formulations have been used to treat wood, especially railroad crossties and switch ties, to prevent insect and fungal attacks for more than 125 years. During this time, the predominant preservative of choice has been creosote. Creosote wood preservatives are based on coal tar creosote (creosote), which is a black or brownish oil made by distilling coal tar that is made after high temperature carbonization of coal. Some of the advantages of creosote are high toxicity to wood destroying organisms, long service life (>20 years) due to its relative insolubility in water and low volatility, and low cost. The creosote wood treatment process includes vacuum-pressure cycles where the creosote solution penetrates the void spaces of the wood sample.

Creosote remains a major wood preservative for railroad crossties and switch ties. However, problems with the availability of creosote as well as costs have created a need for more efficient and cost effective use of this time-tested wood preservative.

To extend the supply, creosote is often mixed with either coal tar or petroleum oil in various proportions. In North America, the American Wood Protection Association (AWPA) has standardized several such creosote products. AWPA P1/P13 creosotes are made from coal tar distillate, AWPA P2 creosote solutions are made from coal tar distillate or solutions of coal tar in coal tar distillate, and AWPA P3 creosote-petroleum solutions are made from 50/50 blends of AWPA P1/P13 creosote and petroleum oils (specified by AWPA P4 standard). The AWPA U1 standard for crossties requires 7-8 pounds per cubic foot (“pcf”) of any creosote product (P1/P13, P2 or P3).

Compared with straight creosote, creosote solutions provide the ability to extend creosote while maintaining acceptable preservative performance. Another benefit is that creosote solutions tend to reduce weathering and checking of the treated wood. Posts and ties treated with creosote blends show better service than those similarly treated with straight creosote (Ibach 1999).

To maintain preservative efficacy, the AWPA P3 standard sets the minimum creosote content at 50%. The addition of alternate co-biocides could allow further reduction of creosote retentions in wood without compromising the overall preservative performance. Several wood preservatives have been combined with creosote, for example, pentachlorophenol, zinc chloride, copper naphthenate, chlorothalonil (Barnes, H. M.; Sanders, M. G.; Lindsey, G.B.; Amburgey, T. L. (2011) Performance of Creosote/Chlorothalonil Preservatives. International Research Group on Wood Preservation, Document No. IRG/WP/11-30580). However, all have been met with limited commercial success.

Another example of co-biocides are borates. Borates are commonly used as a diffusible preservative to protect the interior of refractory species that are not penetrated fully by creosote. For example, Murray (US 2012/0171504 A1) discloses a 1-step method of treating wood with a creosote/borate preservative.

Other combinations of creosote and co-biocides have also been previously disclosed. One example is U.S. Pat. No. 6,348,089 by Marx et al. (“Marx”), and assigned to Lonza AG located in Basel, Switzerland. Marx discloses coal-tar “oil-in-water” emulsions containing biocidally active quaternary ammonium compounds for protecting wood against rot and attack from insects. Marx further describes the addition of propiconazole, a 1, 2, 4-triazole fungicide, to the coal-tar emulsion to provide additional anti-fungal activity to the emulsion.

However, for non-emulsified creosote wood preservative systems, there is still a need for compatible co-biocide formulations. Such a co-biocide formulation must fully solubilize the co-biocide and be fully miscible in various types of creosote solutions in order to uniformly penetrate into the wood during treatment. Further, the co-biocide formulation must prevent “water-in-oil” emulsions from occurring when the preservative comes into contact with aqueous plant cylinder and work tank drippings and/or effluent. Emulsion problems in oil-based wood preservatives systems have been known to cause poor retentions, non-uniform penetration, reduced product performance and early product failure. For creosote preservatives, additional issues include surface bleeding, sludge formation and preservative leaching.

In view of the above, there is still a need for a biocide formulation capable of being added to creosote wood preservatives while enhancing both the preservative efficacy and product performance of creosote treated wood.

### SUMMARY OF THE INVENTION

In one embodiment of the present invention, provided is a liquid biocide concentrate composition for addition to an oil containing composition to form a wood preservative. The liquid biocide concentrate composition contains (i) a biocide in an amount from 0.1 to 50 percent by weight, based on the weight of the biocide composition; (ii) a solvent in an amount from 20 to 80 percent by weight, based on the weight of the biocide composition; and (iii) a stabilizer in an amount from 0 to 50 percent by weight, based on the weight of the biocide composition. The biocide concentrate composition is also substantially free of water.

In another embodiment, provided is an oil-based biocide wood preservative composition. The preservative composition contains a) an oil; and b) a biocide concentrate composition. The biocide concentrate contains (i) a biocide in an amount from 0.1 to 50 percent by weight, based on the weight of the biocide composition; (ii) a solvent in an amount from 20 to 80 percent by weight, based on the weight of the biocide composition; and (iii) a stabilizer in an amount from 0 to 50 percent by weight, based on the weight of the biocide composition. The biocide concentrate composition is also substantially free of water.

In an additional aspect of the present invention, provided is a wood preservative composition containing a) creosote; b) an extending oil; and c) a biocide concentrate composition. The biocide concentrate contains (i) a biocide in an amount from 0.1 to 50 percent by weight, based on the weight of the biocide composition; (ii) a solvent in an amount from 20 to 80 percent by weight, based on the weight of the biocide composition; and (iii) a stabilizer in an amount from 0 to 50 percent by weight, based on the weight of the biocide composition. The biocide concentrate composition is also substantially free of water.

In a further aspect of the present invention, provided is a method for preserving wood from microbial degradation and insect attacks. The method comprises applying an oil-based biocide wood preservative composition to wood. The preservative composition contains a) an oil; and b) a biocide concentrate composition. The biocide concentrate contains (i) a biocide in an amount from 0.1 to 50 percent by weight, based on the weight of the biocide composition; (ii) a solvent in an amount from 20 to 80 percent by weight, based on the weight of the biocide composition; and (iii) a stabilizer in an amount from 0 to 50 percent by weight, based on the weight of the biocide composition. The biocide concentrate composition is also substantially free of water.

In a further embodiment of the present invention, provided is a method of extending creosote wood preserving composition without adversely affecting the creosote containing wood preserving composition. The method includes mixing an extending oil with creosote and a biocide concentrate composition. The biocide concentrate contains (i) a biocide in an amount from 0.1 to 50 percent by weight, based on the weight of the biocide composition; (ii) a solvent in an amount from 20 to 80 percent by weight, based on the weight of the biocide composition; and (iii) a stabilizer in an amount from 0 to 50 percent by weight, based on the weight of the biocide composition. The biocide concentrate composition is also substantially free of water.

### BRIEF DESCRIPTION OF THE DRAWING

FIG. 1 is a bar graph depicting the results of a soil block test carried out following the procedure of the AWPA E10 Standard Method of Testing Wood Preservatives.

### DETAILED DESCRIPTION OF THE INVENTION

As noted above, the present invention advantageously provides a biocide formulation that forms homogeneous, non-emulsifying blends with oil-based wood preservatives, enhancing preservative performance in high decay zones or allowing the oil-based wood preservative to be extended with oil while maintaining current preservative effectiveness. These and other advantages will become more apparent from the description set forth below.

In one embodiment, the present invention provides a biocide concentrate including (i) a biocide, (ii) a solvent, and (iii) a stabilizer. The biocide concentrate formulation is designed to be added to an oil-based wood preservative in an amount that provides antimicrobial and/or insecticidal properties to the wood treated with the oil-based preservative treated wood.

The biocide formulation will generally contain from 0.1-50 wt. % biocide, typically from 5-40 wt. % biocide, and particularity, from 10-30 wt. % biocide. The biocide formulation will generally contain from 20-80 wt. % solvent, typically, from 25-75 wt. % solvent, and particularity, from 30-75 wt. % solvent. The biocide formulation will generally contain from 0-50 wt. % stabilizer, typically, from 5-30 wt. % stabilizer, and particularly, from 10-25 wt. % stabilizer.

Biocides may be selected from organic, metallic, and/or organo-metallic systems. Preferred organic biocides include but are not limited to pentachlorophenol, isothiazolones, carbamates, chlorothalonil, azoles, and permethrin. Preferred organo-metallic biocides include but are not limited to copper naphthenate, zinc naphthenate, and oxine copper. In one particular embodiment, the biocide is an azole compound.

In accordance with the invention, the fungicide of the biocide concentrate may be a triazole fungicide, specifically a 1,2,4-triazole fungicide such as those represented by formula (I) and (II):

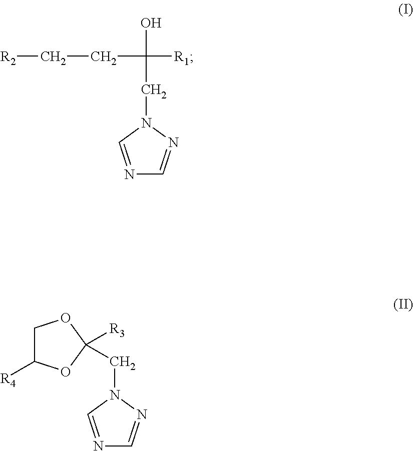

where R₁ is a branched or straight chain C₁₋₅ alkyl group; R₂ is a phenyl group optionally substituted by one or more substituents selected from halogen, C₁₋₃ alkyl, C₁₋₃ alkoxy, phenyl and nitro; R₃ is same as defined for R₂; and R4 is a hydrogen atom, or a branched or straight chain C₁₋₅ alkyl. Exemplary 1,2,4 triazoles include 1,2,4-triazoles selected from the group consisting of azaconazole, bromuconazole, cyproconazole, diclobutrazol, difenoconazole, diniconazole, diniconazole-M, epoxiconazole, etaconazole, fenbuconazole, fiuquinconazole, fiusilazole, fiutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, and combinations thereof. Of particular interest are tebuconazole and propiconazole. In one particular embodiment, the biocide is a combination of tebuconazole and propiconazole. Generally, the tebuconazole and propiconazole are in a molar ratio of 10:1 to 1:10.

As will be appreciated by those skilled in the art, the biocide formulation is designed to create a homogeneous, non-emulsifying blend of the biocide with the oil-based wood preservative. In accordance with the present invention, blending the biocide concentrate into an oil forms a homogeneous oil-based wood preservative. The biocide concentrate is fully soluble in the oil-based biocide preservative in which the mixture of the biocide with the oil does not exhibit instabilities such as haze, precipitation, or phase separation.

In accordance with the present invention, a non-emulsifying blend of the biocide in the oil is defined as a biocide concentrate that does not increase the propensity of various oils to form stable emulsions as measured by the AWPA A35-12 standard “The Determination of the Propensity of a Ready-To-Use Oilborne/Oil-Type Wood Preservative Treating Solution to Form Stable Emulsions”. According to the test procedure, 50 ml of water is mixed with 50 mL of oil-based preservative. Observations are made at 5 minutes, 15 minutes and 30 minutes. This test method measures the depth of the emulsion layer (or “cuff”) between water and oil phases, the extent of migration of oil droplets into the water phase, the extent of migration of water droplets into the oil phase, and any haze formation in either the water and/or oil phases. The best results are those where there is a minimum of emulsion layer between oil and water phases and a maximum of clean, non-hazy oil and water phases in the least time. Extreme care should be taken if the emulsion “cuff” is greater than 10 mL at the end of the 30 minute cycle.

To eliminate formation of “water-in-oil” emulsions in blends of the biocide formulation and creosote, preferred solvents are selected which have less than 100% solubility in water or such solvents are limited to less than 20 wt. % of the biocide formulation. More preferred solvents are selected which have less than 10% solubility of water in solvent at 20° C.

Due to the high temperatures used in the creosote and oil preservative treating process, preferred solvents will have a minimum flash point of 66° C. (150° F.), more preferably 79° C. (174° F.), most preferably 93° C. (200° F.). These high flash point solvents will ensure safe use of the biocide formulations blended into creosote preservatives, but will also reduce solvent evaporation. This will improve penetration and retention of the biocide into the wood as well and increase the service life of the treated wood.

To fully solubilize the biocide, the formulation includes a solvent with high solvent power for the biocide and miscibility with the creosote or the oil into which it is blended. Preferred solvents include but are not limited to acids, alcohols, ethers, esters, ketones, amines, amine oxides, amides and hydrocarbon solvents.

In one embodiment, the solvent is an alcohol including but not limited to 2-ethylhexanol, 2-propylheptanol, iso-nonanol, iso-decanol, and distillation residues (bottoms) of 2-ethylhexanol or 2-propylheptanol. In another embodiment, the solvent is a glycol ether including but not limited to propylene glycol n-butyl ether, dipropylene glycol methyl ether, dipropylene glycol n-butyl ether, tripropylene glycol n-butyl ether, propylene glycol phenyl ether, ethylene glycol 2-ethylhexyl ether, and ethylene glycol hexyl ether. In another embodiment, the solvent is an ester including but not limited to 2-ethylhexyl acetate, Texanol ester alcohol, ethylene glycol n-butyl ether acetate, diethylene glycol monobutyl ether acetate, dibasic esters (including dimethyl glutarate, dimethyl succinate, and dimethyl adipate), butyl lactate and ethylhexyl lactate. In another embodiment, the solvent is a ketone including but not limited to isophorone and distillation residues (bottoms) of C₉-C₁₁ ketones. In another embodiment, the solvent is an amide including but limited to N-methylpyrrolidone and N-octylpyrrolidone. In another embodiment, the solvent is a hydrocarbon including but not limited to mineral spirits, de-aromatized hydrocarbons, isoparrafins and cycloparaffins.

The biocide concentrate also contains a stabilizer including but not limited to anti-blooming agents, tackifying agents, and/or water repellents. The stabilizer reduces surface bleeding of the preservative, prevents blooming (recrystallization) of the preservative, and can reduce leaching. While the solvent provides the solvent power necessary for a stable biocide solution, the stabilizer imparts the necessary miscibility, homogeneity, and non-emulsifying properties when the biocide formulation is blended with creosote preservative solutions. The proper selection of stabilizer can even prevent emulsification when some portion of the solvent is 100% water miscible. The benefits of the combination are greater than can be achieved with either solvent or stabilizer alone.

The anti-blooming agents may be selected from, but not limited to, ester based plasticizers such as dibutyl phthalate, dioctyl phthalate, trixylenyl phosphate, isononyl benzoate, diisononyl phthalate, triacetin, acetyl tributyl citrate, dibutyl sebacate, triethyl citrate, and fatty acid esters such as isopropyl myristate and stearyl laurate. The tackifying agents may be selected from, but not limited to, rosins, terpenes, hydrocarbon resins such as C₉ Hydrocarbon Resins, C₅ Hydrocarbon Resins, Coumarone-Indene Resins, and Dicyclopentadiene Resins, hydrogenated hydrocarbon resins, and terpene-phenol resins. The water repellents is a wax or oil selected from, but not limited to, paraffins, silicones, fatty alcohols, fatty acids, fatty amines, fatty amine ethoxylates, fatty amides, and fatty amine oxides.

The biocide of the present invention is formulated to be blended with an oil to form a wood preservative. Exemplary oils suitable for use in oil-based biocide wood preservatives include, for example, liquid hydrocarbon oils having a high asphaltene content and/or low API gravity, and blends thereof.

The hydrocarbons in crude oil are mostly paraffins (15-60%), naphthenes (30-60%), aromatics (3-30%), with the remainder consisting of resins and asphaltenes, heteroatomic compounds containing nitrogen, oxygen and sulfur, and trace amounts of metals such as iron, nickel, copper and vanadium. Heavy crude oils and petroleum products are more viscous, have higher boiling ranges, and higher densities than lighter oils. They tend to be rich in aromatics and high molecular weight residuals (e.g. asphaltenes, resins and heterocyclics).

API (American Petroleum Institute) gravity is a common way to express the relative masses of crude oils or products. The API gravity is calculated from Specific Gravity (SG) using the following equation:

API gravity (°)=[141.5/SG]−131.5

Extra heavy oils have very low API gravity (<10°) while heavy oils have slightly higher API gravity) (10-22°). The API gravity of medium oils are 22.2°-31.1°, while lighter crude oils have a higher API gravity (>31°).

Heavy oils which include heavy crude oil, residual fuel oil, No. 6 fuel oil and Bunker C oil have the highest asphaltene concentrations (>10%) while light oils such as mineral spirits have the lowest (<2%). Asphaltenes often create stability issues for heavy oils. When heavy oils are mixed with lighter fraction oils or solvents with lower resin and/or aromatic contents, asphaltenes may precipitate or phase separation may occur.

However, heavy oils have certain benefits over lighter oils as carriers for wood preservatives. They are in greater supply and are much less expensive than lighter oils. Further, the aromatic, resin, asphaltene, heterocyclic and metal compounds present in heavy oils provide a wood preservative effect. In fact, 50/50 weight ratio blends of creosote and heavy oils have the same efficacy as 100% creosote. However, beyond this level the heavy oils reduce the preservative effect in wood.

While there are many AWPA standards for oil borne preservatives, the Hydrocarbon Solvents used for these preservatives fall into the category of medium to light oils (API Gravity≧24°). Only creosote uses heavy/extra heavy oils with API Gravity<22°.

In another embodiment, the wood preservative is hydrocarbon oil with high asphaltene content and/or low API gravity. The biocide concentrate enhances the wood preservative efficacy of the hydrocarbon oil while the auxiliary solvent and stabilizer provide fully miscible, non-emulsifying blends of the oil and biocide which are otherwise unstable. Preferably the hydrocarbon oil will have an asphaltene content of at least 3 percent by weight and/or an API gravity of less than about 24°.

In an additional embodiment of the present invention, provided is a wood preservative composition containing a) creosote; b) an extending oil; and c) a biocide concentrate composition. The biocide concentrate contains (i) a biocide in an amount from 0.1 to 50 percent by weight, based on the weight of the biocide composition; (ii) a solvent in an amount from 20 to 80 percent by weight, based on the weight of the biocide composition; and (iii) a stabilizer in an amount from 0 to 50 percent by weight, based on the weight of the biocide composition. The biocide concentrate composition is also substantially free of water. Generally, the creosote containing wood preservative composition will contain a weight ratio of said creosote to said biocide concentrate composition in the range of from about 2000:1 to about 5:1. More particularity, the weight ratio of said creosote to said biocide concentrate composition ranges from about 500:1 to about 25:1.

The creosote based wood preservative is formed using the biocide concentrate when the creosote is extended or diluted with an oil. In particular, the creosote is coal-tar creosote. Coal-tar creosotes to be used in the invention are well-known in the art since creosote has been used for centuries to preserve wood from microbes and insects. The coal-tar creosote is known in the art as the 200° C. to 400° C. boiling fraction of the distillate of coal tar that us produced in the carbonization of bituminous coal to form coke. Conventional coal-tar creosote that may be used include, but are not limited to, the American Wood-Preservers' Creosote Grades of P1/P13, P2 and P3. These standards of creosote are also found in the United States Federal Standards TT-645B and TT-C-655(1). In one particular embodiment, the coal-tar creosote is P1/P13 Creosote Preservative (CR, coal tar distillate). In another embodiment, the coal-tar creosote is P2 Creosote Solution (CR-S, coal tar distillate or a solution of coal tar in coal tar distillate). In another embodiment, the coal-tar creosote is P3 Creosote-Petroleum Solution (CR-PS, 50 percent by volume (“vol. %”) each (a) P1/P13 coal-tar creosote and (b) AWPA P4 petroleum oil).

At times creosote is in short supply which causes wood treaters to dilute creosote with an extending oil. The extending oil serves as diluent for the creosote. The extending oil may further improve the weathering and checking performance of the preservative, but generally the creosote which is diluted with an oil is less effective in preserving the wood. Preferred extending oils fractions to be used in the invention are petroleum distillates conforming to the requirements of AWPA P4 Petroleum Oil for Blending with Creosote. These oils have specific gravity at 15.5° C./15.5° C. (60° F./60° F.) (not greater than 15.9° A.P.I) (ASTM Standard D287) of not less than 0.96. Petroleum oils with lower values of specific gravity may be used provided experience or testing shows that it may be blended into creosote without the formation of excessive sludge. These oils have water and sediment (ASTM Standard D96) not more than 1% by volume. These oils have Flash Point (Pensky-Martens closed cup) (ASTM Standard D 93) not less than 79° C. These oils have kinematic viscosity (centistokes (“cSt”) at 99° C.) (ASTM Standard D 445) between 4.2 and 10.2. Petroleum oils with a higher viscosity may be used provided the penetration requirements are met.

Representative examples of petroleum distillates to be used include, but are not limited to, No. 6 Fuel Oil, Clarified Oil, and Coker Gas Oil. In one embodiment, the oil fraction is a combination of No. 6 Fuel Oil and Clarified Oil. In another embodiment, the oil fraction is straight Coker Gas Oil.

The present invention also provides a method of treating wood with the oil-based wood preservative as described above. The method entails treating a wood sample with an effective amount of the wood preservative. The wood is treated using any creosote treating regimen known in the art. For example, the wood sample can be treated by brushing the wood preservative onto the wood. The wood sample can also be impregnated by exposing the wood to repeated vacuum/pressure cycles where the wood preservative fills the voids within the wood. These and other methods are well known in the art.

In the context of the invention, an “effective amount” of the wood preservative is the amount which inhibits degradation from microbes and insects to less than 3% weight loss as compared to an unexposed sample. One significant advantage of the wood preservative of the invention is increased protection against fungi such as N. lepideus, G. trabeum, and P. placenta. Neat creosote is known to be effective against most fungi with the exception of N. lepideus. For effective treatment of wood against N. lepideus, neat creosote needs to be retained at levels approaching 8 pounds per cubic foot (“pcf”).

However, the effective level of creosote for treated wood such as railroad crossties also depends upon the severity of wood decay in the region in which the treated wood is put into service. The United States, for example, has been divided into five Climate Zones as part of a study of the decay of wood products. These zones represent the severity of wood decay, where Zone 1 has the lowest rate and Zone 5 has the most severe rate. Given equal tonnages and curvature, conventional creosote-only tie lives will be far lower in Zone 5 than in Zone 1 due to environmentally caused wood tie decay. Currently, these higher decay zones require higher than 8 pcf creosote in wood.

Preserving wood with such high creosote levels can be problematic especially at times when there is a shortage of coal-tar creosote. On the other hand, fungicides such as 1, 2, 4-triazole are known for their excellent protection against N. lepideus but have not been traditionally been used in creosote formulations. The current invention would allow a boost in service life in higher decay zones without the requirement for additional levels of creosote while allowing the use of lower levels of creosote for wood placed into service in lower decay zones. This is accomplished by blending an effective amount of the biocide concentrate described above with creosote that has been extended with and oil. It has been discovered, that the biocide concentrate may be blended with oil extended creosote, providing a creosote wood preservative that is as effective as a non-oil extended creosote.

Due to the sensitivity of creosote to emulsion, sludge formation and bleeding, it has been difficult to blend creosote with traditional biocide dispersions or emulsions. Further, the highly complex chemical nature of creosote and petroleum oils can make it difficult to achieve homogeneous creosote biocide blends. The current invention addresses these problems by incorporating a homogeneous and non-emulsifying biocide formulation into creosote-petroleum formulations. The resulting combination of creosote-petroleum preservatives with biocides significantly reduces the amount of preservative needed to protect against fungi such as N. lepideus.

The biocide concentrate formulations are substantially free of surfactants, forms homogeneous, non-emulsifying blends with creosote wood preservatives. A method of treating wood with the creosote/biocide formulation is also provided that does not increase surface bleeding, sludge formation or preservative leaching. Such creosote/biocide formulations enhance preservative performance in high decay zones. In zones of lower decay severity, such creosote/biocide formulations allow creosote to be extended with petroleum oil while maintaining current preservative effectiveness.

The following non-limiting examples help to further illustrate the unique advantages of the present invention.

### EXAMPLE 1

### 1, 2, 4-Triazole (Azole) biocide Formulation (Comparative)

A biocide formulation containing 25 wt. % of 1, 2, 4-triazoles was prepared with components listed in table 1 below by mixing the azoles in solvent until all actives were fully dissolved. A uniform homogeneous solution was obtained.

TABLE 1

| Ingredient | Weight % |
|---|---|
| Tebuconazole | 12.5 |
| Propiconazole | 12.5 |
| Solvent | 75 |

### EXAMPLE 2

### 1, 2, 4-Triazole (Azole) biocide Formulation (Invention)

A biocide formulation containing 25 wt. % of 1, 2, 4-triazoles was prepared with components listed in table 2 below by mixing the azoles in solvent and stabilizer until all actives were fully dissolved. A uniform homogeneous solution was obtained.

TABLE 2

| Ingredient | Weight % |
|---|---|
| Tebuconazole | 12.5 |
| Propiconazole | 12.5 |
| Solvent | 50 |
| Stabilizer | 25 |

### EXAMPLE 3

### 1, 2, 4-Triazole (Azole) biocide Formulation (Invention)

A biocide formulation containing 20 wt. % of 1, 2, 4-triazoles was prepared with components listed in table 3 below by mixing the azoles in solvent and stabilizer until all actives were fully dissolved. A uniform homogeneous solution was obtained.

TABLE 3

| Ingredient | Weight % |
|---|---|
| Tebuconazole | 13.3 |
| Propiconazole | 6.7 |
| Solvent | 70 |
| Stabilizer | 10 |

### EXAMPLE 4

### Enhanced Miscibility of Azole biocide Formulations with AWPA P4-11 Petroleum Oils

Blends of 1% biocide formulation from example 1 with 99% AWPA P4 petroleum oil (50/50 weight ratio No. 6 Fuel Oil and Catalytic Cracked Clarified Oil) were prepared. The solvents selected included: Dipropylene Glycol n-Methyl Ether (DPM), Dipropylene Glycol n-Butyl Ether (DPnB), Tripropylene Glycol n-Butyl Ether (TPnB), Propylene Glycol Phenyl Ether (PPh), and Texanol Ester Alcohol. All blends either formed hazy solutions or separated into two phases.

Blends of 1% azole biocide formulation from example 2 were evaluated with 99% AWPA P4 petroleum oil (50/50 weight ratio No. 6 fuel oil and clarified oil). The solvent was a 75/25 wt. ratio blend of DPnB (low water miscibility) and DPM (high water miscibility) and the stabilizer was a liquid aromatic hydrocarbon resin, Nevchem LR. The formulation was fully miscible with the AWPA P4 petroleum oil blends.

Blends of 1% azole biocide formulation from example 3 were evaluated with 99% AWPA P4 petroleum oil (50/50 weight ratio No. 6 fuel oil and clarified oil). The solvent was a 90/10 wt. ratio blend of DPnB/DPM and the stabilizer was a liquid aromatic hydrocarbon resin, Nevchem LR. The formulation was fully miscible with the AWPA P4 petroleum oil blends.

### EXAMPLE 5

### Non-Emulsifying Properties of the Inventive Formulations

Blends of azole biocide formulations with AWPA P4 petroleum oil (50/50 weight ratio No. 6 Fuel Oil and Catalytic Cracked Clarified Oil) were prepared and evaluated according to AWPA A35-12 standard “The Determination of the Propensity of a Ready-To-Use Oilborne/Oil-Type Wood Preservative Treating Solution to Form Stable Emulsions”. The test determines (a) if an intermediate layer will form between the oil and water phases, (b) if the water layer will contain oil droplets or if the oil layer will contain water droplets, and (c) whether oil or water layers will be clear or turbid. The best results are when there is a tight interface with no turbidity.

A 100 ml graduated cylinder was filled with 50 ml of the azole biocide formulation blend with petroleum oil. Next, 50 ml of distilled water was poured on top. The graduated cylinder was stoppered and then shaken vigorously. The cylinder was set down and observations were made over a 30 minute period.

An azole biocide of Example 2 was prepared with a 75/25 wt. ratio blend of DPnB and DPM (50%) and 25% liquid aromatic hydrocarbon resin, Nevchem LR. When 1% or less of the azole biocide formulation was added to 99% AWPA P4 petroleum oil, no emulsification was observed. Oil droplets were present in the water phase and the water phase was clear with no turbidity.

An azole biocide of Example 3 was prepared with a 90/10 wt. ratio blend of DPnB and DPM (70%) and 10% liquid aromatic hydrocarbon resin, Nevchem LR. When 7.5% or less of the azole biocide formulation was added to AWPA P4 petroleum oil, no emulsification was observed. Oil droplets were present in the water phase and the water phase was clear with no turbidity.

### EXAMPLE 6

### Creosote-Based Preservatives

Two (2) neat creosote samples were used, conforming to (a) AWPA P1/P13 and (b) AWPA P2. Two (2) blends of creosote and AWPA P4 type petroleum oils were prepared. The first blend conformed to AWPA P3 and contained (i) 50 wt. % of P1/P13 creosote; (ii) 25 wt. % of No. 6 Fuel Oil, and (iii) 25 wt. % of Catalytic Cracked Clarified Oil. This blend was designated “P1/P13 Creosote with Oils”. The second blend contained (i) 75 wt. % P2 creosote, and (ii) 25 wt. % Coker Gas Oil. This second blend was designated “P2 Creosote with Coker Gas Oil”.

### EXAMPLE 7

### Enhanced Blends of Creosote-Based Preservatives and Azole biocide Formulation

Two (2) enhanced blends were prepared by addition of the azole biocide formulations from example 2 to (a) P1/P13 Creosote with Oils and (b) P2 Creosote with Coker Gas Oil from example 6. These blends, designated as “P1/P13 Creosote with Oils/Azoles and “P2 Creosote with Coker Gas Oil/Azoles”, were prepared by first incorporating the azole biocide formulation from example 2 (prepared with a 75/25 wt. ratio blend of DPnB and DPM and liquid aromatic hydrocarbon resin, Nevchem LR) into the petroleum oil, then finally the oil/azole biocide formulation was incorporated into creosote.

### EXAMPLE 8

### Anti-Fungal Protection of Wood Blocks

The soil block test is a relatively rapid laboratory method for assessing the decay resistance of wood based materials under conditions that favor rapid fungal growth. The procedure below followed the AWPA E10 Standard Method of Testing Wood Preservatives by Laboratory Soil-Block Cultures. In this test, southern yellow pine (19 mm³) wood blocks were evaluated for weight loss due to degradation by fungi: Neolentinus lepideus (N. lepideus), Gloephyllum trabeum (G. trabeum), and Postia placenta (P. placenta). All three species cause brown rot, but N. lepideus is also tolerant of creosote, G. trabeum of pentachlorophenol and arsenic, and P. placenta of copper compounds.

The AWPA U1 specification for creosote for crossties is typically 7-8 pounds per cubic foot (“pcf”), depending upon the species of wood. At these levels, creosote is able to control both G. trabeum and P. placenta while being less effective against N. lepideus. However, when creosote is diluted with hydrocarbon oils, the efficacy of the preservative is reduced. When creosote levels are 2 pcf or less, wood becomes easily degraded by brown rot fungi.

The treated wood blocks were prepared by vacuum impregnation as described in the AWPA E10 standard. A desiccator or bell jar is connected to a suitable auxiliary flask for holding the treating solution as well as a vacuum gauge. Typically, the blocks were exposed to 30 minutes vacuum (approx. 100 mm Hg) followed by introduction of the treating solution and release of vacuum. The blocks were allowed to remain submerged in the treating solution for approximately 1 hour after vacuum has been released.

Blocks were treated with either (i) toluene, (ii) P1/P13 creosote, (iii) P2 creosote, (iv) P1/P13 Creosote with Oils described in example 6, (v) P2 Creosote with Coker Gas Oil described in example 6, (vi) P1/P13 Creosote with Oils/Azoles described in example 7, and (vii) P2 Creosote with Coker Gas Oil/Azoles described in example 7. Samples of untreated wood were also evaluated as a control. Gauge retentions were determined by measuring preservative solution uptake for the blocks. All treatments were performed to achieve retentions of 2, 4 or 8 pcf total preservative solution. Preservative concentration in the treating solution was adjusted by dilution with toluene. Treatments containing azoles were performed to achieve retentions of 0.004-0.012 pcf azoles.

All treated and untreated blocks were tested against N. lepideus. Untreated blocks and a few selected treatments were also tested against G. trabeum and P. placenta for comparison. According to the AWPA E10 standard, seven (7) blocks were supplied per treatment group. The blocks were weighed, conditioned, and five (5) blocks from each treatment group were exposed to test fungi and incubated while two (2) control blocks were incubated without fungi. At the end of the incubation period, the blocks were weighed to determine weight loss as a measure of the effect of fungal exposure. According to performance standards, a good wood preservative should have less than 3% of mean weight loss in treated blocks.

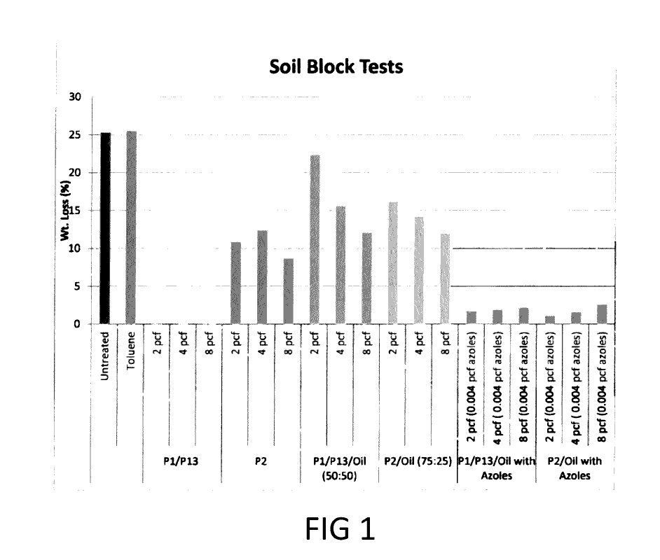

The results of the soil test are listed in Table 4, the creosote/oil blends with the azole concentrate provided superior protection against N. lepideus. In fact, they were the only treatments that demonstrated weight loss percentages below the 3% threshold. Wood blocks treated with 2 pcf creosote/oil blends (25% of AWPA U1 retentions for CR and CR-PS) with azole concentrate exhibited ˜⅙^{th} the weight loss observed for neat P1/P13 creosote at 8 pcf (AWPA U1 CR retention) and ˜ 1/7^{th} the weight loss observed for the 50% P1/P13 creosote/50% petroleum oil blend at 8 pcf (AWPA U1 CR-PS retention). This data is also graphically represented in FIG. 1.

TABLE 4

| | Retention (pcf) | | | | | |
|---|---|---|---|---|---|---|
| | | | Concentrate | Wt. loss % | | |
| Treatment | Creosote | Oil | (Azoles) | N. lepideus | G. trabeum | P. placenta |
| Untreated | — | — | — | 25.32 | 46.41 | 40.28 |
| Toluene | — | — | — | 25.46 | 44.55 | 52.14 |
| P1/P13 Creosote | 2 | — | — | 11.65 | — | — |
| | 4 | — | — | 9.55 | — | — |
| | 8 | — | — | 10.19 | — | — |
| P2 Creosote | 2 | — | — | 10.84 | — | — |
| | 4 | — | — | 12.37 | — | — |
| | 8 | — | — | 8.66 | — | — |
| P1/P13 | 1 | 1 | — | 22.4 | — | — |
| Creosote with | 2 | 2 | — | 15.6 | — | — |
| Oils¹ | 4 | 4 | — | 12.1 | — | — |
| P2 Creosote with | 1.5 | 0.5 | — | 16.2 | — | — |
| Coker Gas Oil² | 3 | 1 | — | 14.2 | — | — |
| | 6 | 2 | — | 12.0 | 2.95 | 2.11 |
| P1/P13 Creosote | 1 | 0.984 | 0.016 (.004) | 1.68 | — | — |
| with Oils/Azoles³ | 2 | 1.984 | 0.016 (.004) | 1.92 | — | — |
| | 4 | 3.984 | 0.016 (.004) | 2.20 | — | — |
| | 4 | 3.952 | 0.048 (.012) | 1.92 | 1.04 | 1.24 |
| P2 Creosote with | 1.5 | 0.484 | 0.016 (.004) | 1.10 | — | — |
| Coker Gas | 3 | 0.984 | 0.016 (.004) | 1.61 | — | — |
| Oil/Azoles⁴ | 6 | 1.987 | 0.016 (.004) | 2.59 | — | — |

¹50% PI/P13 Creosote with 50% Oil Fraction (25% No.: 6 Fuel oil and 25% Clarified Oil).
²75% P2 Creosote with 25% Oil Fraction (Coker Gas Oil).
³Same as 1 but with Azole Concentrate.
⁴Same as 2 but with Azole Concentrate.

We claim:

1. A liquid biocide concentrate composition for addition to a wood preservative, the liquid biocide concentrate composition, comprising:
(i) a biocide in an amount from 0.1 to 50 percent by weight, based on the weight of the biocide composition;
(ii) a solvent in an amount from 20 to 80 percent by weight, based on the weight of the biocide composition; and
(iii) a stabilizer in an amount from 0 to 50 percent by weight, based on the weight of the biocide composition; and the biocide concentrate composition is substantially free of water.

2. The biocide concentrate composition according to claim 1, wherein (i) the biocide is present in an amount from 5 to 40 percent by weight, based on the weight of the biocide composition; (ii) the solvent is present in an amount from 25 to 80 percent by weight, based on the weight of the biocide composition; and (iii) the stabilizer is present in an amount from 5 to 30 percent by weight, based on the weight of the biocide composition.

3. The biocide concentrate composition according claim 2, wherein (i) the biocide is present in an amount from 10 to 30 percent by weight, based on the weight of the biocide composition;
(ii) the solvent in an amount from 30 to 75 percent by weight, based on the weight of the biocide composition; and (iii) the stabilizer in an amount from 10 to 25 percent by weight, based on the weight of the biocide composition.

4. The biocide concentrate composition according to claim 1, wherein the biocide is selected from the group consisting of pentachlorophenol; isothiazolones; carbamates; chlorothalonil; 1, 2, 4-triazoles; permethrin; copper naphthenate; zinc naphthenate; and oxine copper.

5. The biocide concentrate composition according to claim 1, wherein the solvent is selected from the group consisting of acids, alcohols, ethers, esters, ketones, amines, amine oxides, amides and hydrocarbon solvents.

6. The biocide concentrate composition according to claim 1, wherein the stabilizer is an anti-blooming, tackifying, and/or water repellent agent.

7. The biocide concentrate composition according to claim 4, wherein the biocide is a 1,2,4-triazole selected from the group consisting of azaconazole, bromuconazole, cyproconazole, diclobutrazol, difenoconazole, diniconazole, diniconazole-M, epoxiconazole, etaconazole, fenbuconazole, fiuquinconazole, fiusilazole, fiutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, and combinations thereof.

8. The biocide concentrate composition according to claim 7, wherein the 1,2,4-triazole fungicide is a combination of tebuconazole and propiconazole.

9. The biocide concentrate composition according to claim 8, wherein tebuconazole and propiconazole are in a molar ratio of 10:1 to 1:10.

10. The biocide concentrate composition according to claim 5, wherein the solvent selected from the group consisting of propylene glycol n-butyl ether, dipropylene glycol methyl ether, dipropylene glycol n-butyl ether, tripropylene glycol n-butyl ether, propylene glycol phenyl ether, ethylene glycol 2-ethylhexyl ether, and ethylene glycol hexyl ether, 2-ethylhexyl acetate, Texanol ester alcohol, ethylene glycol n-butyl ether acetate, diethylene glycol monobutyl ether acetate, dimethyl glutarate, dimethyl succinate, dimethyl adipate, butyl lactate, ethylhexyl lactate, isophorone, ketone bottoms, 2-ethylhexanol, 2-propylheptanol, isononanol, isodecanol, distillation residues (bottoms) of 2-ethylhexanol or 2-propylheptanol, and aliphatic, isoparaffinic, cycloaliphatic, aromatic hydrocarbon fluids and mixtures thereof.

11. The biocide concentrate composition according to claim 6, wherein the antiblooming agent is an ester based plasticizer including dibutyl phthalate, dioctyl phthalate, trixylenyl phosphate, isononyl benzoate, diisononyl phthalate, triacetin, acetyl tributyl citrate, dibutyl sebacate, or triethyl citrate; the tackifying agent is selected from rosins, terpenes, hydrocarbon resins, Coumarone-lndene Resins, and Dicyclopentadiene Resins, hydrogenated hydrocarbon resins, or terpene-phenol resins; and the water repellent is a wax or oil selected from paraffin, silicones, fatty alcohols, fatty acids, fatty acid esters, fatty amines, fatty amine ethoxylates, fatty amides, and fatty amine oxides.

12. An oil-based biocide wood preservative composition comprising
a) an oil; and
b) a biocide concentrate composition comprising:
(i) a biocide in an amount from 0.1 to 50 percent by weight, based on the weight of the biocide concentrate composition;
(ii) a solvent in an amount from 20 to 80 percent by weight, based on the weight of the biocide concentrate composition; and
(iii) a stabilizer in an amount from 0 to 50 percent by weight, based on the weight of the biocide concentrate composition; and the biocide concentrate composition is substantially free of water.

13. The oil-based biocide wood preservative composition according to claim 12, wherein the oil is selected from the group consisting of liquid hydrocarbon oils having a high asphaltene content and/or low API gravity, and blends thereof.

14. The oil-based biocide wood preservative composition to claim 12, wherein the biocide is selected from the group consisting of pentachlorophenol; isothiazolones; carbamates; chlorothalonil; 1, 2, 4-triazoles; permethrin; copper naphthenate; zinc naphthenate; and oxine copper.

15. The oil-based biocide wood preservative composition to claim 12, wherein the solvent is selected from the group consisting of acids, alcohols, ethers, esters, ketones, amines, amine oxides, amides and hydrocarbon solvents.

16. The oil-based biocide wood preservative composition to claim 12, wherein the stabilizer is an anti-blooming, tackifying, and/or water repellent agent.

17. The oil-based biocide wood preservative composition to claim 14, wherein the biocide is a 1,2,4-triazole selected from the group consisting of azaconazole, bromuconazole, cyproconazole, diclobutrazol, difenoconazole, diniconazole, diniconazole-M, epoxiconazole, etaconazole, fenbuconazole, fiuquinconazole, fiusilazole, fiutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, and combinations thereof.

18. The oil-based biocide wood preservative composition to claim 17, wherein the 1,2,4-triazole fungicide is a combination of tebuconazole and propiconazole.

19. The oil-based biocide wood preservative composition to claim 18, wherein tebuconazole and propiconazole are in a molar ratio of 10:1 to 1:10.

20. The oil-based biocide wood preservative composition to claim 15, wherein the solvent selected from the group consisting of propylene glycol n-butyl ether, dipropylene glycol methyl ether, dipropylene glycol n-butyl ether, tripropylene glycol n-butyl ether, propylene glycol phenyl ether, ethylene glycol 2-ethylhexyl ether, and ethylene glycol hexyl ether, 2-ethylhexyl acetate, Texanol ester alcohol, ethylene glycol n-butyl ether acetate, diethylene glycol monobutyl ether acetate, dimethyl glutarate, dimethyl succinate, dimethyl adipate, butyl lactate, ethylhexyl lactate, isophorone, ketone bottoms, 2-ethylhexanol, 2-propylheptanol, isononanol, isodecanol, distillation residues (bottoms) of 2-ethylhexanol or 2-propylheptanol, and aliphatic, isoparaffinic, cycloaliphatic, aromatic hydrocarbon fluids and mixtures thereof.

21. The oil-based biocide wood preservative composition to claim 6, wherein the antiblooming agent is an ester based plasticizer including dibutyl phthalate, dioctyl phthalate, trixylenyl phosphate, isononyl benzoate, diisononyl phthalate, triacetin, acetyl tributyl citrate, dibutyl sebacate, or triethyl citrate; the tackifying agent is selected from rosins, terpenes, hydrocarbon resins, Coumarone-lndene Resins, and Dicyclopentadiene Resins, hydrogenated hydrocarbon resins, or terpene-phenol resins; and the water repellent is a wax or oil selected from paraffin, silicones, fatty alcohols, fatty acids, fatty acid esters, fatty amines, fatty amine ethoxylates, fatty amides, and fatty amine oxides.

22. A wood preservative composition comprising
a) creosote
b) an extending oil; and
c) a biocide concentrate composition comprising:
(i) a biocide in an amount from 0.1 to 50 percent by weight, based on the weight of the biocide concentrate composition;
(ii) a solvent in an amount from 20 to 80 percent by weight, based on the weight of the biocide concentrate composition; and
(iii) a stabilizer in an amount from 0 to 50 percent by weight, based on the weight of the biocide concentrate composition; and the biocide concentrate composition is substantially free of water.

23. The wood preservative composition according the claim 22, wherein the weight ratio of said creosote to said biocide concentrate composition ranges from about 2000:1 to about 5:1.

24. The wood preservative composition according the claim 23, wherein the weight ratio of said creosote to said biocide concentrate composition ranges from about 500:1 to about 25:1.

25. The wood preservative composition according to claim 22, wherein , biocide is a 1,2,4-triazole fungicide selected from the group consisting of azaconazole, bromuconazole, cyproconazole, diclobutrazol, difenoconazole, diniconazole, diniconazole-M, epoxiconazole, etaconazole, fenbuconazole, fiuquinconazole, fiusilazole, fiutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, and combinations thereof.

26. The wood preservative composition according to claim 25, wherein the 1,2,4-triazole fungicide is a combination of tebuconazole and propiconazole.

27. The wood preservative composition according to claim 26, wherein tebuconazole and propiconazole are in a molar ratio of 10:1 to 1:10.

28. The wood preservative composition according to claim 22, wherein the solvent is selected from the group consisting of acids, alcohols, ethers, esters, ketones, amines, amine oxides, amides and hydrocarbon solvents.

29. The oil-based biocide wood preservative composition according to claim 22, wherein the stabilizer is an anti-blooming, tackifying, and/or water repellent agent.

30. The oil-based biocide wood preservative composition according to claim 29, wherein the antiblooming agent is an ester based plasticizer including dibutyl phthalate, dioctyl phthalate, trixylenyl phosphate, isononyl benzoate, diisononyl phthalate, triacetin, acetyl tributyl citrate, dibutyl sebacate, or triethyl citrate; the tackifying agent is selected from rosins, terpenes, hydrocarbon resins, Coumarone-lndene Resins, and Dicyclopentadiene Resins, hydrogenated hydrocarbon resins, or terpene-phenol resins; and the water repellent is a wax or oil selected from paraffin, silicones, fatty alcohols, fatty acids, fatty acid esters, fatty amines, fatty amine ethoxylates, fatty amides, and fatty amine oxides.

31. A method for preserving wood from microbial degradation and insect attacks, said method comprises applying the composition according to claim 12 to the wood to be preserved.

32. A method of extending creosote wood preserving composition containing creosote without adversely affecting the wood preserving composition, said method comprising mixing an extending oil with creosote and the biocide concentrate composition according to anyone of claim 1.
